(19) United States
(12) Patent Application Publication
(10) Pub. No.: US 2025/0219738 A1
(43) Pub. Date: Jul. 3, 2025

(54) OPTICAL DEVICE FOR WIRELESS DATA COMMUNICATION

(71) Applicants: HYUNDAI MOTOR COMPANY, SEOUL (KR); KIA CORPORATION, SEOUL (KR)

(72) Inventor: Seong Hwan Kim, Hwaseong-si (KR)

(73) Assignees: HYUNDAI MOTOR COMPANY, SEOUL (KR); KIA CORPORATION, SEOUL (KR)

(21) Appl. No.: 18/668,896

(22) Filed: May 20, 2024

(30) Foreign Application Priority Data
Dec. 27, 2023 (KR) 10-2023-0192662

(51) Int. Cl. H04B 10/516; G02F 1/21; H01Q 15/02; H01Q 15/24

(52) U.S. Cl. CPC H04B 10/516; G02F 1/212; H01Q 15/02; H01Q 15/24

(57) ABSTRACT

An optical device for wireless data communications includes a light source outputting light, a light modulator modulating the output light, a focal plane array including a plurality of optical antennas arranged on a same plane and emitting light modulated by the light modulator through a selected optical antenna among the plurality of optical antennas, and an optical lens converting light emitted from the focal plane array into light having a predetermined beam angle and outputting corresponding light externally.

### CROSS REFERENCE TO RELATED APPLICATIONS

This application claims benefit of priority to Korea patent Application No. 10-2023-0192662 filed on Dec. 27, 2023 in the Korean Intellectual Property Office, the disclosure of which is incorporated herein by reference in its entirety.

### BACKGROUND

### 1. Field

The present disclosure relates to an optical device for wireless data communications.

### 2. Description of Related Art

Recently, research on silicon photonics-based focal plane array (FPA) has been continuously conducted to implement a scanner, an essential component of a light detection and ranging (LIDAR) sensor.

The silicon photonics-based FPA is a technology that integrates multiple components within a single silicon chip to reduce power consumption and increase a data transfer rate.

The silicon photonics-based FPA is applied to a LiDAR sensor and may simply measure distance and detect objects using light, but is not used to transmit and receive data wirelessly.

### SUMMARY

An aspect of the present disclosure is to provide an optical device for wireless data communications, capable of wirelessly transmitting and receiving data using a silicon photonics-based focal plane array.

According to an aspect of the present disclosure, an optical device for wireless data communications includes a light source outputting light, a light modulator modulating the output light, a focal plane array including a plurality of optical antennas arranged on a same plane and emitting light modulated by the optical modulator through a selected optical antenna among the plurality of optical antennas, and an optical lens converting light emitted from the focal plane array into light having a predetermined beam angle and outputting corresponding light externally.

According to another aspect of the present disclosure, an optical device for wireless data communications includes an optical lens receiving light having a predetermined beam angle from an external source and outputting the received light, a focal plane array including a plurality of optical antennas arranged on a same plane and receiving light output from the optical lens through a selected optical antenna among the plurality of optical antennas, a photodetector detecting an intensity of the received light, and an amplifier amplifying the detected intensity of the light.

According to another aspect of the present disclosure, an optical device for wireless data communications includes a light source outputting light, a light modulator modulating the output light, a photodetector detecting an intensity of light, an amplifier amplifying the detected intensity of the light, an optical lens converting the light modulated by the optical modulator into light having a predetermined beam angle and outputting the corresponding light externally, and receiving the light having a predetermined beam angle from an external source and outputting the corresponding light, a focal plane array including a plurality of optical antennas arranged on a same plane, emitting light modulated by the optical modulator to the optical lens through a selected optical antenna among the plurality of optical antennas and receiving light output from the optical lens through the selected optical antenna, and a circulator providing light modulated by the optical modulator to the focal plane array and providing light received from the focal plane array to the photodetector.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 is a block diagram illustrating an optical device for wireless data communications according to an embodiment of the present disclosure, in which a transmission-side optical device and a receiving-side optical device are illustrated;

FIG. 2 is a perspective view illustrating an operating principle of a focal plane array according to an embodiment of the present disclosure;

FIG. 3 is a schematic diagram illustrating an operating principle of a focal plane array according to an embodiment of the present disclosure;

FIGS. 4A to 4B illustrate an optical switch selection circuit including an optical switch; and

FIG. 5 is a block diagram of an optical device for wireless data communications according to another embodiment of the present disclosure, in which a transmission-side optical device and a receiving-side optical device are integrated.

### DETAILED DESCRIPTION

Hereinafter, embodiments of the present disclosure are described with reference to the accompanying drawings. The following description is provided to aid in a comprehensive understanding of methods, devices, and/or systems disclosed in the particularities. However, the following description is merely exemplary and is not intended to limit the present disclosure.

In the following description of the present disclosure, a detailed description of known functions and configurations incorporated herein will be omitted when it would make the subject matter of the present disclosure unclear. The terms used in the present specification are defined in consideration of functions used in the present disclosure, and may be changed according to the intent or conventionally used methods of clients, operators, and users. Accordingly, definitions of the terms should be understood on the basis of the entire description of the present specification. Terms used in the following description are merely provided to describe embodiments of the present disclosure and are not intended to be limiting of the inventive concept. As used herein, the singular forms “a,” “an” and “the” are intended to include the plural forms as well, unless the context clearly indicates otherwise. It will be further understood that the terms “comprises” or “has” when used in this specification, specify the presence of stated features, integers, steps, operations, elements, or a portion or combination thereof, but do not preclude the presence or addition of one or more other features, integers, steps, operations, elements, or a portion or combination thereof.

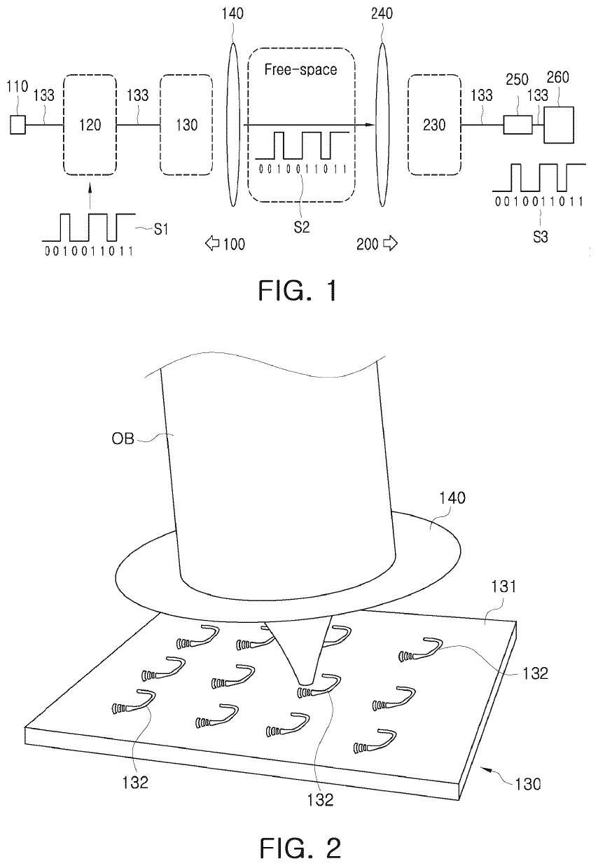

FIG. 1 is a block diagram illustrating an optical device for wireless data communications according to an embodiment of the present disclosure, in which a transmission-side optical device and a receiving-side optical device are illustrated.

As illustrated in FIG. 1, a transmission-side optical device 100 may include a light source 110, an optical modulator 120, a focal plane array 130, and an optical lens 140, and these components may be connected through an optical waveguide 133.

The light source 110 may output light and may be, for example, a laser diode.

The optical modulator 120 may modulate light output from the light source 110 according to an electrical signal S1, and the modulated light may be transmitted to the focal plane array 130. This optical modulator 120 may include any one of a Mach-Zehnder modulator (MZM), a ring modulator, and an electro-absorption modulator (EAM).

Meanwhile, the focal plane array 130 may include a plurality of optical antennas arranged on the same plane and emit light modulated by the optical modulator 120 to the optical lens 140 through a selected optical antenna among the plurality of optical antennas.

In addition, the optical lens 140 may convert light emitted from the focal plane array 130 into light having a predetermined beam angle and output the same to free space. The optical lens 140 described above may be a convex lens.

Here, the beam angle may be determined according to Equation 1 below.

$$θ = {tan}^{- 1} ( x / f ) \qquad Equation 1$$

Here, θ may be the beam angle, x may be a distance between an optical axis of the optical lens and a selected optical antenna, and f may be a focal length of the optical lens.

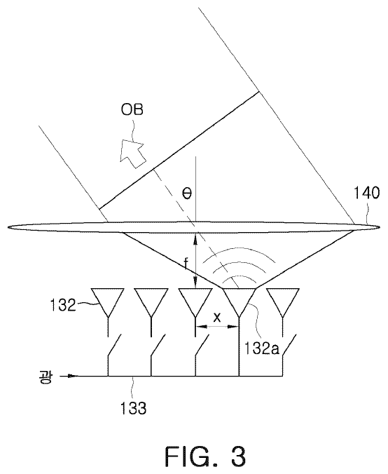

FIG. 2 is a perspective view illustrating an operating principle of a focal plane array according to an embodiment of the present disclosure, and FIG. 3 is a schematic diagram illustrating an operating principle of a focal plane array according to an embodiment of the present disclosure.

As illustrated in FIGS. 2 and 3, the focal plane array 130 may include a substrate 131 and a plurality of optical antennas 132 arranged on the substrate 131. The plurality of optical antennas 132 may be arranged, for example, in the form of N×N (N is a natural number).

That is, one optical antenna 132a among the plurality of optical antennas 132 may be selected through an optical switch, light modulated through the selected optical antenna 132a may be emitted to the optical lens 140, and the optical lens 140 may convert the light emitted from the focal plane array 130 into light having a predetermined beam angle and output the same to free space. Reference numeral OB (output beam) refers to light output from the optical lens 140. The optical switch may include at least one of an optical integrated circuit-based thermo-optical effect optical switch, an electro-optical effect optical switch, and a MEMS optical switch.

Here, the aforementioned beam angle θ may be obtained according to Equation 1 above based on the aforementioned equation 1 based on the focal length f of the optical lens 140 and a distance x between an optical axis of the optical lens 140 and the selected optical antenna 132a.

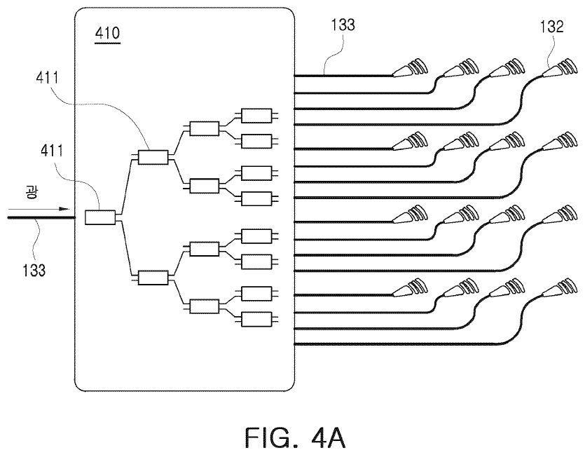

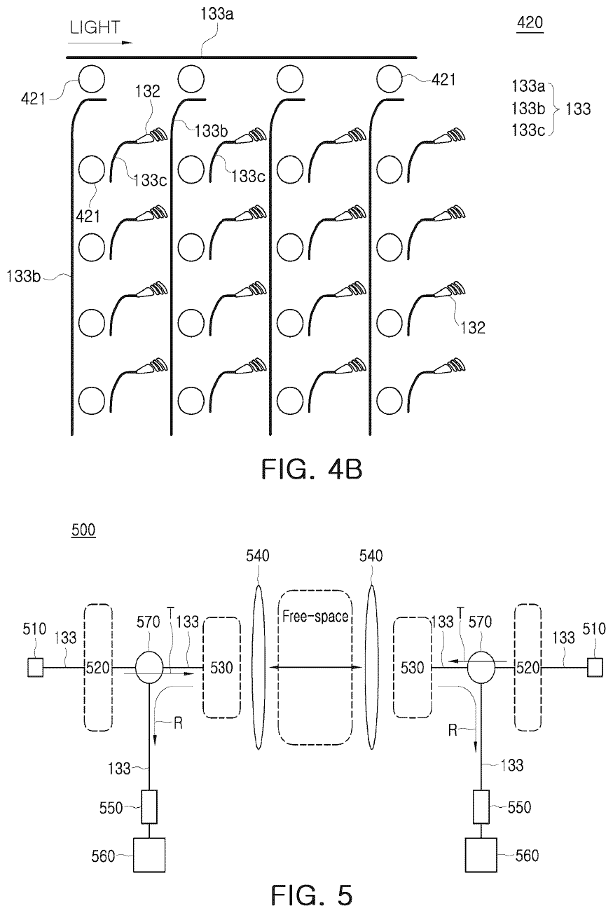

FIGS. 4A and 4B illustrate an optical switch selection circuit including an optical switch. The optical switch selection circuit may be implemented on the substrate 131.

Specifically, FIG. 4A illustrates a case in which the optical antenna 132 is selected through an 1×N optical switch network 410.

As illustrated in FIG. 4A, the 1×N optical switch network 410 may include optical switches 411 in a cascading structure. As desired optical switches 411 are turned on sequentially or in parallel, light incident through the optical waveguide 133 may be emitted through the selected optical antenna 132. Here, the optical switch 411 may be a Mach Zehnder Interferometer (MZI).

Meanwhile, FIG. 4B illustrates a case in which the optical antenna 132 is selected using a micro ring resonator (MRR) switch as the optical switch 421.

As illustrated in FIG. 4B, the optical waveguide 133 may include a main optical waveguide 133a, a plurality of first sub-optical waveguides 133b branched off from the main optical waveguide 133a through an optical switch 421, and a plurality of second sub-optical waveguides 133c branched off from the plurality of first sub-optical waveguides 133b through the optical switch 421, and the optical antennas 132 may be connected to the plurality of second sub-optical waveguides 133c. As desired optical switches 421 are turned on sequentially or in parallel, light incident through the optical waveguide 133a may be emitted through the selected optical antenna 132.

Meanwhile, the light source 110, the light modulator 120, and the focal plane array 130 may be manufactured based on silicon photonics.

Meanwhile, in the case of using an external light source as the light source 110, the light modulator 120 and the focal plane array 130 may be manufactured based on silicon photonics, and the light source 110 described above may be connected to the light modulator 120 through an optical waveguide.

The transmission-side optical device 100 may be used for vehicle-to-everything (V2X) communications.

The descriptions given above with reference to FIGS. 2 to 4B illustrating the focal plane array 130 and the optical lens 140 provided in the transmission-side optical device 100 may also be applied to a focal plane array 230 and an optical lens 240 provided in a receiving-side optical device 200. In addition, it should be noted that the aforementioned FIGS. 2 to 4B are intended to help understanding of the present disclosure, and the present disclosure is not limited to the structure described above.

Referring back to FIG. 1, the receiving-side optical device 200 may include the optical lens 240, the focal plane array 230, a photodetector 250, and an amplifier 260, and these components may be connected through the optical waveguide 133.

Specifically, the optical lens 240 may receive light having a predetermined beam angle from free space and output the same to the focal plane array 230.

The focal plane array 230 may include a plurality of optical antennas arranged on the same plane, receive light output from the optical lens 240 through a selected optical antenna among the plurality of optical antennas, and transmit the received light to the photodetector 250.

The optical lens 240 and the focal plane array 230 are the same as those described above with reference to FIGS. 2 to 4B, and a redundant description thereof will be omitted here.

The photodetector 250 may detect the intensity of light received from the focal plane array 230 and convert the same into an electrical signal.

The amplifier 260 may amplify the electrical signal from the photodetector 250.

This amplifier 260 may be, for example, a trans-impedance amplifier (TIA).

In the receiving-side optical devices 200, the focal plane array 230, the photodetector 250, and the amplifier 260 may be manufactured based on silicon photonics.

In addition, the receiving-side optical device 200 may be used for vehicle-to-everything (V2X) communications.

Meanwhile, FIG. 5 is a block diagram of an optical device for wireless data communications according to another embodiment of the present disclosure, in which a transmission-side optical device and a receiving-side optical device are integrated. An optical device 500 for wireless data communications may include a light source 510, an optical modulator 520, a focal plane array 530, an optical lens 540, a photodetector 550, an amplifier 560, and a circulator 570.

Specifically, the light source 510 may output light and may be, for example, a laser diode.

The optical modulator 520 may modulate light output from the light source 510 according to an electrical signal, and the modulated light may be transmitted to the focal plane array 530. The optical modulator 520 may include any one of a Mach-Zehnder modulator (MZM), a ring modulator, and an electro-absorption modulator (EAM).

The focal plane array 530 may include a plurality of optical antennas arranged on the same plane, emit light modulated by the optical modulator 520 to the optical lens 540 through a selected optical antenna among the plurality of optical antennas, and receive light output from the optical lens 540 through the selected optical antenna.

The focal plane array 530 described above may include a substrate and a plurality of optical antennas arranged on the substrate, and the plurality of optical antennas 132 may be arranged in the form of, for example, N×N (N is a natural number) as described above.

Also, the optical lens 540 may convert light emitted from the focal plane array 530 into light having a predetermined beam angle and output the same to free space, and may receive light having a predetermined beam angle from free space and output the same to the circulator 570. The optical lens 540 described above may be a convex lens.

The aforementioned beam angle θ may be obtained according to Equation 1 described above based on a focal length f of the optical lens 540 and a distance x between an optical axis of the optical lens 540 and the selected optical antenna.

The photodetector 550 may detect the intensity of light, convert the same into an electrical signal, and then transmit the electrical signal to the amplifier 560, and the amplifier 560 may amplify the electrical signal.

Meanwhile, the circulator 570 may provide light modulated by the optical modulator 520 to the focal plane array 530 (see T), and provide light received from the focal plane array 530 to the photodetector 550 (see R).

The light source 510, light modulator 520, focal plane array 530, photodetector 550, amplifier 560, and circulator 570 described above may be manufactured based on silicon photonics.

Alternatively, the light modulator 520, focal plane array 530, photodetector 550, amplifier 560, and circulator 570 described above may be manufactured based on silicon photonics, and the light source 510 may be connected to the optical modulator 520 through the optical waveguide 133.

In addition, the optical device 500 for wireless communications described above may be used for vehicle-to-everything (V2X) communications.

As described above, according to an embodiment of the present disclosure, data may be transmitted and received wirelessly using the silicon photonics-based focal plane array.

According to an embodiment of the present disclosure, data may be transmitted and received wirelessly using the silicon photonics-based focal plane array.

While example embodiments have been illustrated and described above, it will be apparent to those skilled in the art that modifications and variations could be made without departing from the scope of the present disclosure as defined by the appended claims.

1. An optical device for wireless data communications, the optical device comprising:
a light source configured to output light;
a light modulator configured to modulate the output light;
a focal plane array including a plurality of optical antennas arranged on a same plane, and configured to emit light modulated by the light modulator through a selected optical antenna among the plurality of optical antennas; and
an optical lens configured to convert light emitted from the focal plane array into light having a predetermined beam angle, and to output corresponding light externally.

2. The optical device of claim 1, wherein the light modulator includes any one of a Mach-Zehnder modulator (MZM), a ring modulator, and an electro-absorption modulator (EAM).

3. The optical device of claim 1, wherein the focal plane array further includes:
a substrate;
the plurality of optical antennas arranged on the substrate;
an optical waveguide configured to guide light modulated by the light modulator to each of the plurality of optical antennas; and
a plurality of optical switches connecting the optical waveguide to one of the plurality of optical antennas.

4. The optical device of claim 1, wherein the predetermined beam angle is determined according to the following equation:
$$θ = {tan}^{- 1} ( x / f ) ,$$
wherein θ is the beam angle, x is a distance between an optical axis of the optical lens and the selected optical antenna, and f is a focal length of the optical lens.

5. The optical device of claim 1, wherein the light source, the light modulator, and the focal plane array are manufactured based on silicon photonics.

6. The optical device of claim 1, wherein the optical device for wireless communications is used for vehicle-to-everything (V2X) communications.

7. The optical device of claim 1, wherein the light modulator and the focal plane array are manufactured based on silicon photonics, and the light source is connected to the light modulator through an optical waveguide.

8. An optical device for wireless data communications, the optical device comprising:
an optical lens configured to receive light having a predetermined beam angle from an external source, and to output the received light;
a focal plane array including a plurality of optical antennas arranged on a same plane, and configured to receive light output from the optical lens through a selected optical antenna among the plurality of optical antennas;
a photodetector configured to detect an intensity of the received light; and
an amplifier configured to amplify the detected intensity of the light.

9. The optical device of claim 8, wherein the predetermined beam angle is determined according to the following equation:
$$θ = {tan}^{- 1} ( x / f )$$
wherein θ is the beam angle, x is a distance between an optical axis of the optical lens and the selected optical antenna, and f is a focal length of the optical lens.

10. The optical device of claim 8, wherein the focal plane array includes:
a substrate;
the plurality of optical antennas arranged on the substrate;
an optical waveguide configured to guide light received from each of the plurality of optical antennas; and
a plurality of optical switches connecting the optical waveguide to one of the plurality of optical antennas.

11. The optical device of claim 8, wherein the focal plane array, the photodetector, and the amplifier are manufactured based on silicon photonics.

12. The optical device of claim 8, wherein the optical device for wireless communications is used for vehicle-to-everything (V2X) communications.

13. An optical device for wireless data communications, the optical device comprising:
a light source configured to output light;
a light modulator configured to modulate the light;
a photodetector configured to detect an intensity of the light;
an amplifier configured to amplify the detected intensity of the light;
an optical lens configured to convert the light modulated by the light modulator into light having a predetermined beam angle, and to output the corresponding light externally, and to receive the light having a predetermined beam angle from an external source and output the corresponding light;
a focal plane array including a plurality of optical antennas arranged on a same plane, the focal plane array configured to emit light modulated by the light modulator to the optical lens through a selected optical antenna among the plurality of optical antennas, and to receive light output from the optical lens through the selected optical antenna; and
a circulator configured to provide light modulated by the light modulator to the focal plane array, and to provide light received from the focal plane array to the photodetector.

14. The optical device of claim 13, wherein the light modulator includes any one of a Mach-Zehnder modulator (MZM), a ring modulator, and an electro-absorption modulator (EAM).

15. The optical device of claim 13, wherein the focal plane array further includes:
a substrate;
the plurality of optical antennas arranged on the substrate;
an optical waveguide configured to guide light modulated by the light modulator to each of the plurality of optical antennas; and
a plurality of optical switches connecting the optical waveguide to one of the plurality of optical antennas.

16. The optical device of claim 13, wherein the predetermined beam angle is determined according to the following equation:
$$θ = {tan}^{- 1} ( x / f )$$
wherein θ is the beam angle, x is a distance between an optical axis of the optical lens and the selected optical antenna, and f is a focal length of the optical lens.

17. The optical device of claim 13, wherein the light source, the light modulator, the focal plane array, the photodetector, the amplifier, and the circulator are manufactured based on silicon photonics.

18. The optical device of claim 13, wherein the optical device for wireless communications is used for vehicle-to-everything (V2X) communications.

19. The optical device of claim 13, wherein the light modulator, the focal plane array, the photodetector, the amplifier, and the circulator are manufactured based on silicon photonics, and the light source is connected to the light modulator through an optical waveguide.
